(19) United States
(12) Patent Application Publication
(10) Pub. No.: US 2024/0212920 A1
(43) Pub. Date: Jun. 27, 2024

(54) INDUCTOR AND DC-DC CONVERTER USING THE SAME

(71) Applicant: TDK Corporation, Tokyo (JP)

(72) Inventor: Tomofumi KURODA, Tokyo (JP)

(73) Assignee: TDK Corporation, Tokyo (JP)

(21) Appl. No.: 18/396,244

(22) Filed: Dec. 26, 2023

(30) Foreign Application Priority Data
Dec. 27, 2022 (JP) 2022-209867

(51) Int. Cl. H01F 27/28; H01F 27/245

(52) U.S. Cl. CPC H01F 27/2847; H01F 27/245; H01F 2027/2861; H01F 27/292

(57) ABSTRACT

In the inductor, when a voltage is applied via each terminal portion, a current flows through each of the first and second coil conductors. At this time, coupling may occur between the first and second coil conductors. However, since the first magnetic body is provided in the inductor, coupling between the first and second coil conductors is suppressed. In addition, since the pair of second magnetic bodies is additionally provided, high inductance can be realized.

### CROSS-REFERENCE TO RELATED APPLICATIONS

This application is based upon and claims the benefit of priority from Japanese Patent Application No. 2022-209867, filed on 27 Dec. 2022, the entire content of which is incorporated herein by reference.

### TECHNICAL FIELD

The present disclosure relates to an inductor and a DC-DC converter using the same.

### BACKGROUND

Japanese Patent Application Publication No. 2021-19141 (Patent Document 1) discloses an inductor having a configuration where a plurality of magnetic cores provided with a coil conductor therein and a plurality of shield portions having a higher magnetic permeability than the magnetic core are arranged, and the inductor including the plurality of coil conductors in one component. In the inductor in Patent Document 1, coupling between two of the adjacent magnetic cores is suppressed by the shield portion interposed between the two of the adjacent magnetic cores.

### SUMMARY

An inductor according to one aspect of the present disclosure includes an element body including a first body portion constituted of material containing magnetic material, the element body having a rectangular parallelepiped outer shape and having a pair of first side surfaces facing each other in a first direction, a pair of second side surfaces facing each other in a second direction perpendicular to the first direction, and a pair of third side surfaces facing each other in a third direction perpendicular to both the first direction and the second direction, a first coil conductor having a first conductor extending along the first direction in the element body, a second conductor extending along the first direction in the element body and adjacent to the first conductor in the second direction, and a third conductor extending along the second direction in the element body and connecting end portions on one side in the first direction of the first and second conductors, a second coil conductor aligned with the first coil conductor in the third direction, the second coil conductor having the first conductor, the second conductor, and the third conductor, a first magnetic body provided in the element body and having a magnetic permeability higher than that of the first body portion, the magnetic body having a rectangular parallelepiped outer shape and interposed between the first coil conductor and the second coil conductor in the third direction and having a pair of forth side surfaces facing each other in the first direction, a pair of fifth side surfaces facing each other in the second direction, and a pair of sixth side surfaces facing each other in the third direction, and a pair of second magnetic bodies provided in the element body and having a magnetic permeability higher than that of the first body portion, each of the second magnetic bodies having a rectangular parallelepiped outer shape, provided in an area different from an area where the first magnetic body is provided in a cross section perpendicular to the first direction, and having a pair of seventh side surfaces facing each other in the first direction, a pair of eighth side surfaces facing each other in the second direction, and a pair of ninth side surfaces facing each other in the third direction, wherein, in a cross section perpendicular to the first direction, the first element body portion of the element body is located at least outside of the first and second conductors of each of the first and second coil conductors in the second direction.

### BRIEF DESCRIPTION OF THE DRAWINGS

FIG. 1 is a schematic perspective view showing an inductor according to one embodiment.

FIG. 2 is an end view of the inductor of FIG. 1.

FIG. 3 is an exploded perspective view showing a coil conductor and a magnetic body of the inductor of FIG. 1.

FIG. 4 is a schematic perspective view showing the coil conductor of FIG. 3.

FIG. 5 is a front view of the coil conductor of FIG. 3.

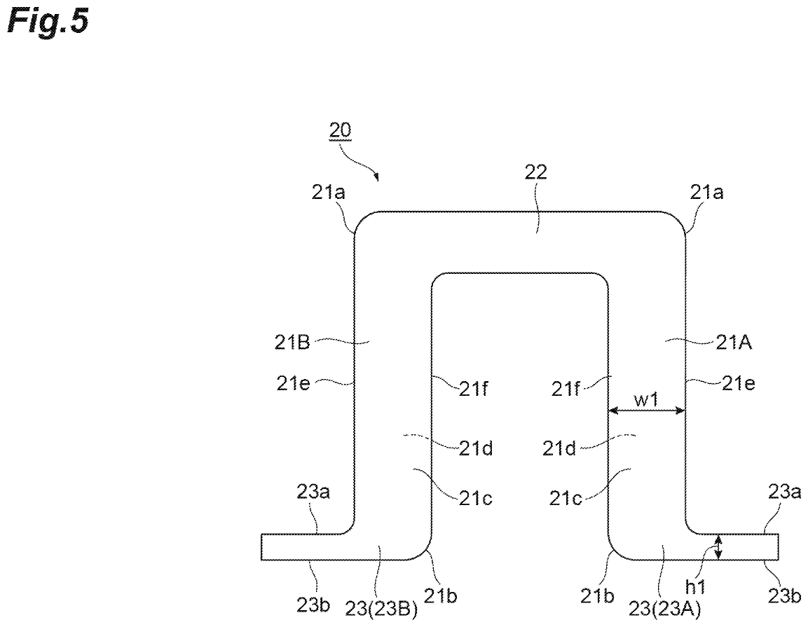

FIG. 6 is a diagram showing the configuration of the magnetic body shown in FIG. 1.

FIG. 7 is a view showing a magnetic body of a different embodiment.

FIG. 8 is a cross-sectional view of the inductor of FIG. 1 taken along line VIII-VIII.

FIG. 9 is a diagram showing a different configuration of inductor.

FIG. 10 is a diagram showing a different configuration of inductor.

FIG. 11 is a diagram showing a different configuration of inductor.

FIG. 12 is a cross-sectional view of the inductor of FIG. 11 taken along line XII-XII.

FIG. 13 is a diagram showing a different configuration of inductor.

FIG. 14 is a circuit diagram of a DC-DC converter using the inductor shown in FIG. 1.

### DETAILED DESCRIPTION

Hereinafter, embodiments of the present disclosure will be described in detail with reference to the accompanying drawings. In the description, the same reference numerals are used for the same elements or elements having the same functions, and redundant description will be omitted.

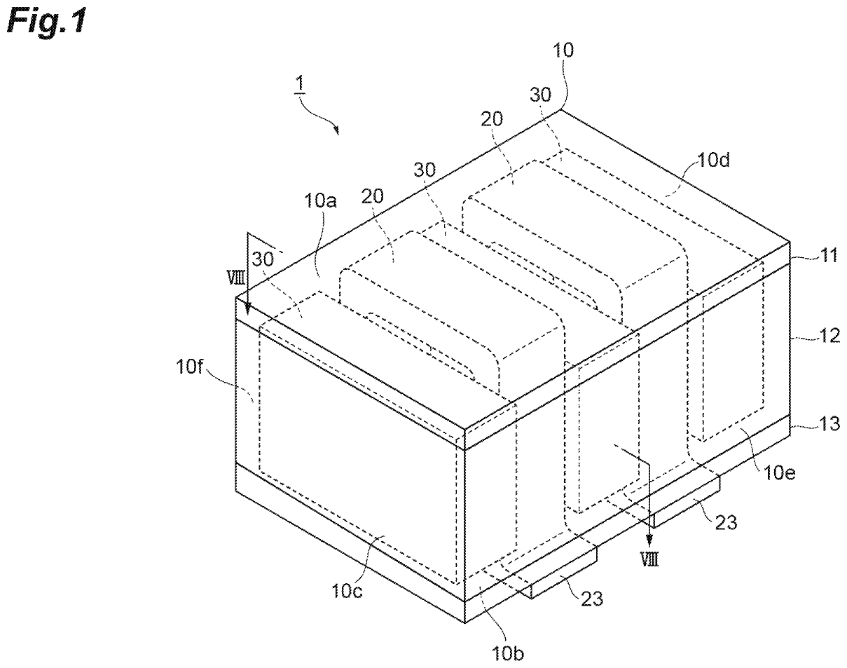

FIG. 1 shows an inductor 1 according to one embodiment. The inductor 1 is composed of an element body 10, a pair of coil conductors 20, and three magnetic bodies 30. That is, the inductor 1 according to the present embodiment is a multiple inductor in which two inductors are provided.

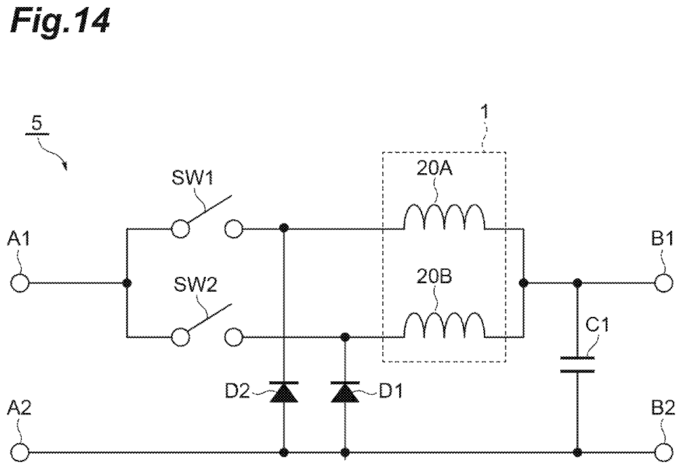

The pair of the coil conductors 20 (20A and 20B) included in the inductor 1 can be adopted for each choke coil of the circuit of the DC-DC converter 5 shown in FIG. 14. The DC-DC converter 5 is a multi-phase converter which includes a pair of conversion units including switching elements SW1 and SW2, choke coils 20A and 20B, diodes D1 and D2, and the pair of conversion units are connected in parallel. The inductor 1 can be adopted as the choke coil 20A and 20B of each conversion unit. More specifically, the DC-DC converter 5 includes a pair of input terminals A1 and A2, a pair of output terminals B1 and B2, the switching element SW1 and the choke coil 20A connected in series between the input terminal A1 and the output terminal B1 in this order, the switching element SW2 and the choke coil 20B connected in series between the input terminal A1 and the output terminal B1 in this order, and a capacitor C1 connected between the output terminals B1 and B2. A circuit of the switching element SW1 and the choke coil 20A and a circuit of the switching element SW2 and the choke coil 20B are connected in parallel between the input terminal A1 and the output terminal B1. The input terminal A2 and the output terminal B2 constitute a ground line. The diode D1 is reversely connected between the connection point of the switching element SW1 and the choke coil 20A and the ground line, and the diode D2 is reversely connected between the connection point of the switching element SW2 and the choke coil 20B and the ground line. The switching elements SW1 and SW2 are alternately turned on and off by a control circuit (not shown), whereby an output voltage obtained by dropping an input voltage is generated. By configuring the pair of the choke coil 20A and 20B in the DC-DC converter 5 with a pair of the coil conductors 20 of the inductor 1, the number of parts configuring the DC-DC converter 5 can be reduced.

The element body 10 has a substantially rectangular parallelepiped outer shape. The element body 10 has an upper surface 10a and a lower surface 10b (a pair of first surfaces) facing each other in the vertical direction which is the first direction, a pair of side surfaces 10e and 10f (a pair of second surfaces) facing each other in the second direction perpendicular to the first direction, and a pair of end surfaces 10c and 10d (a pair of third surfaces) facing each other in the third direction perpendicular to both the first and second directions. The element body 10 according to the present embodiment includes a first element body portion 11, a second element body portion 12, and a third element body portion 13. The first element body portion 11 constitutes the upper surface 10a of the element body 10, the third element body portion 13 constitutes the lower surface 10b of the element body 10, and the second element body portion 12 is interposed between the first and third element body portions 11 and 13 in the vertical direction of the element body 10.

The pair of coil conductors 20 and three magnetic bodies 30 are provided in the element body 10. The pair of coil conductors 20 are arranged along the facing direction of the end surfaces 10c and 10d of the element body 10, and the magnetic body 30 is located between the coil conductors 20 and outside of the coil conductors 20. In the following description, of the pair of the coil conductor 20, the coil conductor 20 located on the end surface 10c side is referred to as a first coil conductor 20A, and the coil conductor 20 located on an end surface 10d side is referred to as a second coil conductor 20B, as necessary. Also, of three magnetic bodies 30, the magnetic body 30 interposed between the pair of the coil conductors 20 is referred to as a first magnetic body 30A, and the magnetic bodies 30 located outside the pair of coil conductors 20 is referred to as second magnetic bodies 30B, as necessary.

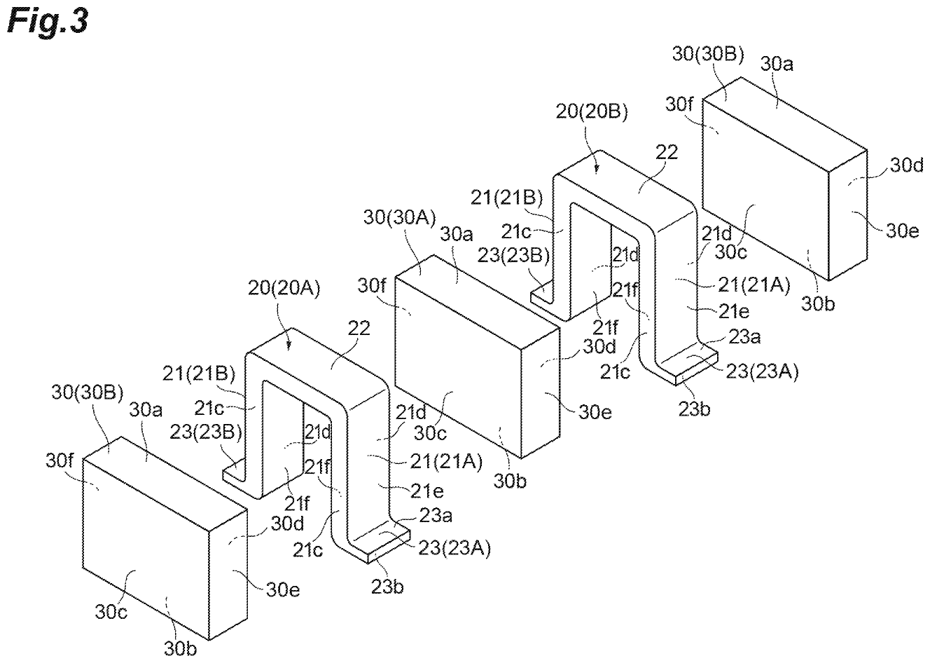

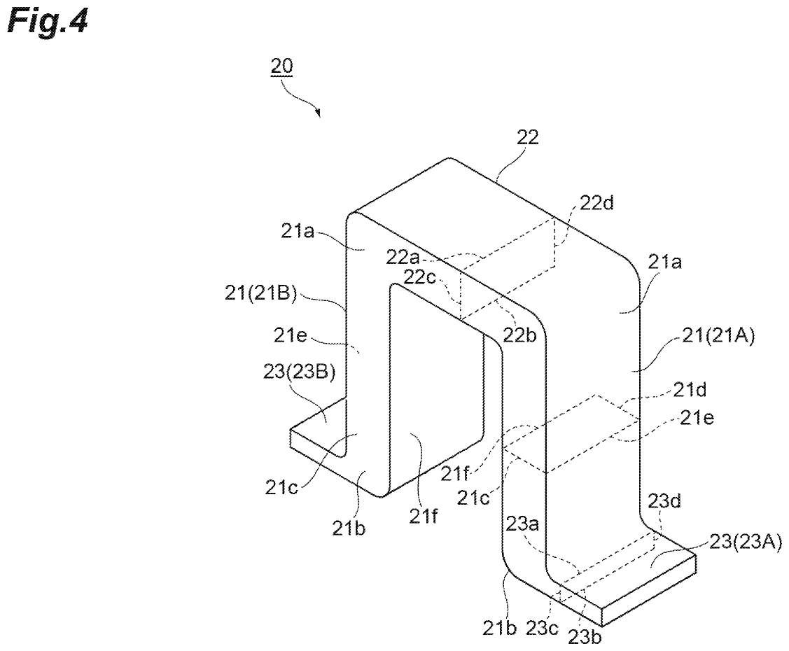

As shown in FIGS. 3 and 4, each of the pair of coil conductors 20 has a configuration in which one elongated strip-shaped conductor is waved like a substantially rectangular wave. Each of the coil conductors 20 can be formed, for example, by bending a single elongated strip conductor. More specifically, each of the coil conductors 20 includes a pair of a juxtapositional portions 21, a connecting portion 22, and a pair of terminal portions 23. Each of the coil conductors 20 is made of a metal selected from Cu, Ag, Au, Al, and Ni, and is made of Cu in the present embodiment. The surface of each of the coil conductors 20 may be covered with an insulating coating (not shown). For example, each of the juxtapositional portions 21 and the connecting portion 22 may be covered with an insulating coating.

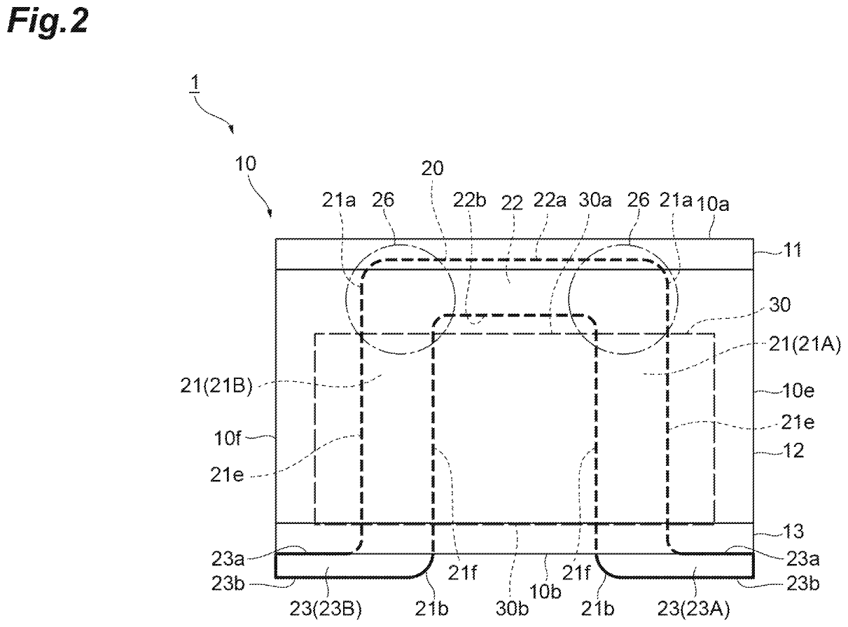

The pair of the juxtapositional portions 21 are composed of a first juxtapositional portion 21A (first conductor) and a second juxtapositional portion 21B (second conductor). The first juxtapositional portion 21A and the second juxtapositional portion 21B have the same length and extend parallel to each other. In a state where the coil conductors 20 are attached to the element body 10 as shown in FIG. 2, the pair of the juxtapositional portions 21 extends in the thickness direction of the element body 10 (i.e., a first direction in which the upper surface 10a and the lower surface 10b face each other). Hereinafter, the extending direction of the juxtapositional portion 21 is also referred to as a first direction. Each of the first juxtapositional portion 21A and the second juxtapositional portion 21B have an upper end portion 21a located on the upper surface 10a side, and the upper end portion 21a are aligned in the facing direction of the pair of the side surfaces 10e and 10f. Similarly, the first juxtapositional portion 21A and the second juxtapositional portion 21B have a lower end portion 21b located on the lower surface 10b side, and the lower end portions 21b are aligned in the facing direction of the pair of side surface 10e and 10f. As shown in FIG. 4, each of the pair of juxtapositional portions 21 has a rectangular cross section in a cross section perpendicular to its extending direction, has side surfaces 21c and 21d parallel to the end surfaces 10c and 10d of the element body 10, and has an outer side surface 21e and an inner side surface 21f parallel to the side surfaces 10e and 10f of the element body 10. The side surface 21c of the juxtapositional portion 21 faces toward the end surface 10c of the element body 10 and the side surface 21d faces toward the end surface 10d of the element body 10. Each of the outer side surfaces 21e of the juxtapositional portions 21 faces outward. Each of the inner side surfaces 21f faces inward and the inner side surfaces 21f face each other.

The connecting portion 22 (third conductor) is a portion connecting the upper end portions 21a of the juxtapositional portions 21, and extends in a straight line in the facing direction of the side surfaces 10e and 10f of the element body 10. Hereinafter, the extending direction of the connecting portion 22 is also referred to as a second direction. As shown in FIG. 4, the connecting portion 22 has a rectangular cross section in a cross section perpendicular to its extending direction. The connecting portion 22 has an upper surface 22a and a lower surface 22b parallel to the upper surface 10a and the lower surface 10b of the element body 10. The connecting portion 22 has side surfaces 22c and 22d parallel to the end surfaces 10c and 10d of the element body 10. The side surface 22c of the connecting portion 22 faces toward the end surface 10c of the element body 10 and the side surface 22d faces toward the end surface 10d of the element body 10. A connection part 26 of the juxtapositional portion 21 and the connecting portion 22 (see FIG. 2) is curved at right angle, and outer and inner surfaces of the connection part 26 constitute curved surfaces.

A pair of terminal portions 23 (fourth conductors) are ends of the coil conductor 20 and extend away from each the lower end portions 21b of the juxtapositional portions 21. In a state where the coil conductors 20 are attached to the element body 10 as shown in FIG. 2, the pair of the terminal portions 23 are exposed on the lower surface 10b of the element body 10 and extends in the facing direction of the side surfaces 10e and 10f. Specifically, of the pair of the terminal portion 23, a first terminal portion 23A extends toward the side surface 10e and a second terminal portion 23B extends toward the side surface 10f. As shown in FIG. 4, each of the terminal portions 23 has a rectangular cross section in a cross section perpendicular to its extending direction. Each of the terminal portions 23 has an upper surface 23a and a lower surface 23b parallel to the upper surface 10a and the lower surface 10b of the element body 10. Each of the terminal portions 23 has side surfaces 23c and 23d parallel to the end surfaces 10c and 10d of the element body 10. The side surface 23c of the terminal portion 23 faces toward the end surface 10c of the element body 10 and the side surface 23d faces toward the end surface 10d of the element body 10. In the present embodiment, the height h1 (i.e., the dimension in the first direction) of each of the terminal portions 23 is designed to be shorter than the width W1 (i.e., the dimension in the second direction) of each of the juxtapositional portions 21. The pair of the terminal portions 23 function as terminal of the inductor 1, and can be electrically connected to terminals on the circuit board on which the inductor 1 is surface-mounted. In the present embodiment, the pair of the terminal portions 23 end on the lower surface 10b, but may be extended to extend along the side surfaces 10e and 10f as necessary. Further, the pair of terminal portions 23 may extend along the facing direction of the side surfaces 10e and 10f so as to approach each other as long as they are not in contact with each other. The coil conductors 20 may be configured without the pair of terminal portions 23, in which case the lower end portions 21b of the juxtapositional portions 21 can be electrically connected to terminals on the circuit board on which the inductor 1 is surface-mounted.

Each of the magnetic bodies 30 has a rectangular plate-shaped outer shape and extends in parallel to a plane including the first direction and the second direction. The first magnetic body 30A has an upper surface 30a and a lower surface 30b (a pair of forth side surfaces) facing each other in the first direction, a pair of side surfaces 30e and 30f (a pair of fifth side surfaces) facing each other in the second direction, and a pair of end surfaces 30c and 30d (a pair of sixth side surfaces) facing each other in the third direction. The second magnetic body 30B has an upper surface 30a and a lower surface 30b (a pair of seventh side surfaces) facing each other in the first direction, a pair of side surfaces 30e and 30f (a pair of eighth side surfaces) facing each other in the second direction, and a pair of end surfaces 30c and 30d (a pair of ninth side surfaces) facing each other in the third direction. The upper surface 30a and the lower surface 30b of each of the magnetic bodies 30 are parallel to the upper surface 10a and the lower surface 10b of the element body 10, respectively. The end surfaces 30c and 30d of each of the magnetic bodies 30 are parallel to the end surfaces 10c and 10d of the element body 10, respectively. The side surfaces 30e and 30f of each of the magnetic bodies 30 are parallel to the side surfaces 10e and 10f of the element body 10, respectively. As shown in FIG. 2, the upper surface 30a of each of the magnetic bodies 30 is located below the upper surface 22a of the connecting portion 22 of each of the coil conductors 20. The lower surface 30b of each of the magnetic bodies 30 is not exposed to the lower surface 10b of the element body 10, and the third element body portion 13 is interposed between the magnetic bodies 30 and the lower surface 10b in the vertical direction. The height position of the upper surface 30a of each of the magnetic bodies 30 may be lower than the height position of the lower surface 22b of the connecting portion 22 of each of the coil conductors 20, or may be between the height positions of the upper surface 22a and the lower surface 22b of the connecting portion 22 of each of the coil conductors 20.

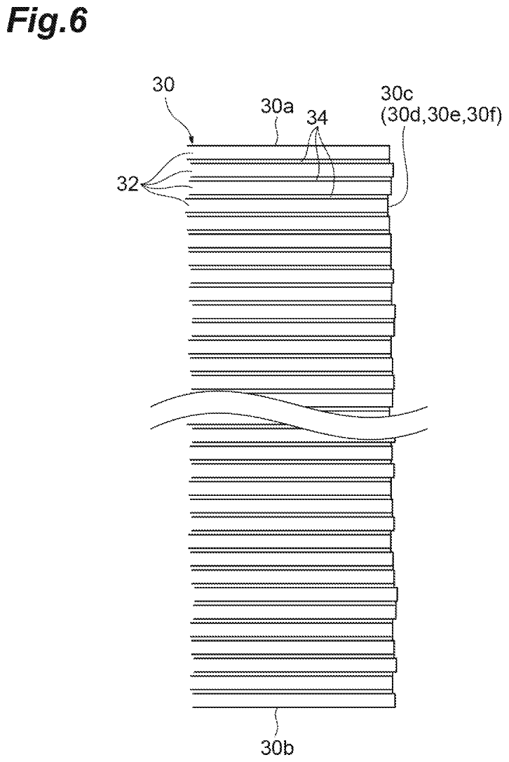

Each of the magnetic bodies 30 is configured to have a relatively high magnetic permeability, and may be designed to have a magnetic permeability higher than that of magnetic powder-containing resin constituting the second element body portion 12 and the third element body portion 13, which will be described later. As shown in FIG. 6, each of the magnetic bodies 30 according to the present embodiment includes a plurality of magnetic ribbons 32 (more specifically, ribbons made of metallic soft magnetic material) stacked in the vertical direction of the element body 10 (that is, the first direction), and has a stacked structure in which a plurality of the magnetic ribbons 32 and a plurality of adhesive layer 34 are alternately arranged. The upper surface 30a and the lower surface 30b of each of the magnetic bodies 30 may be composed of the magnetic ribbon 32 or the adhesive layer 34. The number of the magnetic ribbons 32 constituting each the magnetic body 30 is, for example, 120. The magnetic ribbon 32 may be made of, for example, an amorphous alloy, a microcrystalline alloy, a permalloy, a magnetic alloy such as an alloy having a nanohetero structure. The amorphous alloy material is, for example, a Fe-based amorphous soft magnetic material, a Co-based amorphous soft magnetic material. The microcrystalline alloy is, for example, a Fe-based nanocrystalline soft magnetic material. The nanohetero structure refers to a structure in which microcrystals exist in an amorphous. The surface of each of the magnetic bodies 30 may be covered with an insulating coating (not shown) as necessary.

Since the magnetic body 30 according to the present embodiment is configured to include the plurality of magnetic ribbons 32, the end surfaces 30c and 30d and the side surfaces 30e and 30f are unlikely to be even (smooth or flat), and some degree of unevenness (concave-convex surface) is generated over the entire length in the vertical direction. The concave-convex surface is in contact with the second element body 12. As a result, the magnetic body 30 has rougher surfaces in the end surfaces 30c and 30d, the side surfaces 30e and 30f than in the upper surface 30a and the lower surface 30b. The rough surfaces improve adhesion to the element body 10 in contact with the magnetic body 30.

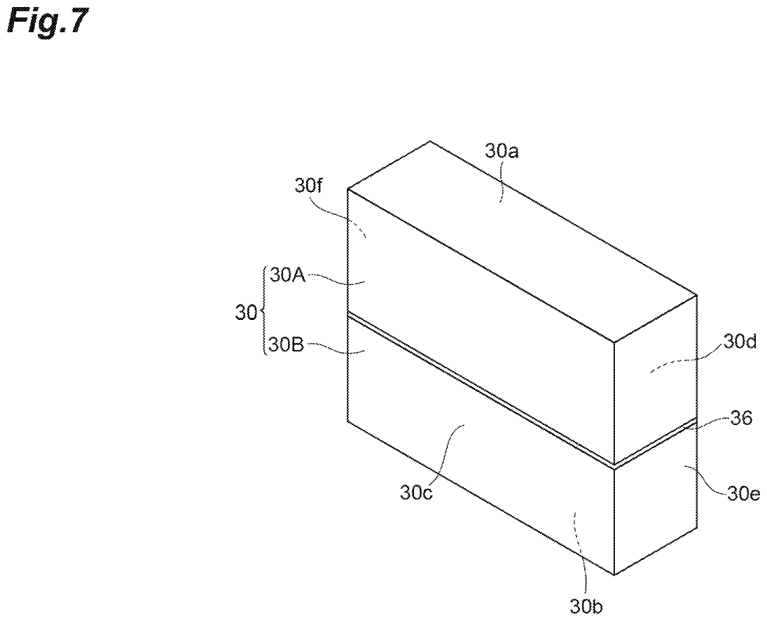

Each of the magnetic bodies 30 may be composed of a plurality of blocks (magnetic blocks). For example, as shown in FIG. 7, the magnetic body 30 may be composed of two magnetic body blocks 30M and 30N that stack in the vertical direction. Each of the magnetic body blocks 30M and 30N has a laminated structure in which the plurality of magnetic ribbons 32 and the plurality of adhesive layers 34 shown in FIG. 6 are alternately arranged. The magnetic body blocks 30M and 30N are adhered by an adhesive layer 36. The material of the adhesive layer 36 may be the same as or different from the material of the adhesive layer 34 included in the magnetic body blocks 30M and 30N. Each of the magnetic bodies 30 is not limited to a laminated structure, and may be a single-layer structure, for example, a single-layer ferrite block.

Next, arrangement of each of the coil conductors 20 and each of the magnetic bodies 30 provided in the element body 10 will be described in more detail.

As shown in FIGS. 1 and 2, the element body 10 has a structure in which the first element body portion 11, the second element body portion 12, and the third element body portion 13 are arranged in order from the top. The first element body portion 11 (second element body portion) is made of a non-magnetic resin, for example, a liquid crystal polymer. The second element body portion 12 (first element body portion) and the third element body portion 13 (third element body portion) are both made of material containing magnetic material, for example, magnetic powder-containing resin (in particular, thermosetting resin containing soft magnetic metal powder). The soft magnetic metal powder is, for example, Fe, Fe—Si alloy, a permalloy, a sendust, amorphous, microcrystalline alloy, or combination thereof. As the thermosetting resin, for example, an epoxy resin can be used. The materials of the second element body portion 12 and the third element body portion 13 may be the same or different. The first element body portion 11 may include magnetic material, and may be the same material as the material of the second element body portion 12 or the material of the third element body portion 13.

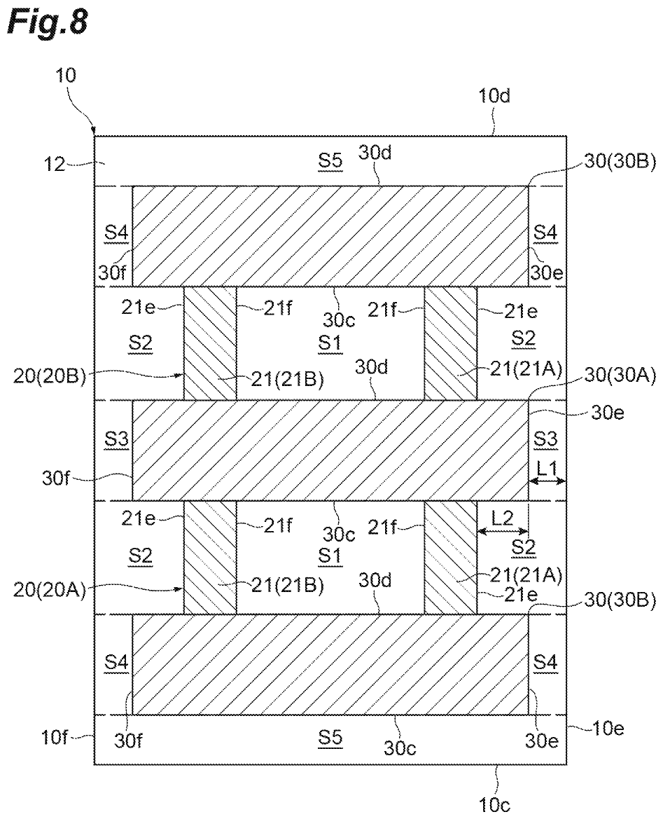

The first element body portion 11 composes the upper surface 10a of the element body 10 and has a generally flat profile extending parallel to the upper surface 10a. The third element body portion 13 composes the lower surface 10b of the element body 10 and has a generally flat profile extending parallel to the lower surface 10b. The second element body portion 12 is sandwiched vertically between the first element body portion 11 and the third element body portion 13 and extends parallel to the upper surface 10a and the lower surfaces 10b of the element body 10. As shown in the cross-sectional view of FIG. 8, more specifically, the second element body portion 12 has five areas S1 to S5. Of the five areas, the first area S1 is an area between the first juxtapositional portion 21A and the second juxtapositional portion 21B in the second direction, the second area S2 is an area between the juxtapositional portion 21 and the side surface 10e and 10f in the second direction, the third area S3 is an area between the first magnetic body 30A and the side surfaces 10e and 10f, the fourth area S4 is an area between the second magnetic body 30B and the side surfaces 10e and 10f, and the fifth area S5 is an area closer to the end surfaces 10c and 10d than the second magnetic body 30B.

Each of the first area S1 is in contact with the inner side surface 21f of each of the juxtapositional portions 21A and 21B of the coil conductors 20, and is also in contact with the end surfaces 30c and 30d of the first and second magnetic bodies 30A and 30B. Each of the second area S2 is in contact with the outer side surface 21e of each of the juxtapositional portions 21A and 21B of the coil conductors 20, and is also in contact with the end surfaces 30c and 30d of the magnetic bodies 30, and constitutes a part of the side surfaces 10e and 10f of the element body 10. Each of the third area S3 is in contact with the side surface 30e and 30f of the first magnetic body 30A and constitutes a part of the side surfaces 10e and 10f of the element body 10. Each of the fourth area S4 is in contact with the side surfaces 30e and 30f of the second magnetic body 30B and constitutes a part of the side surfaces 10e and 10f of the element body 10. Each of the fifth area S5 is in contact with the end surfaces 30c and 30d of the second magnetic bodies 30B and constitutes a part of the end surfaces 10c and 10d of the element body 10.

In the present embodiment, in the cross section shown in FIG. 8, the first magnetic body 30A and the second magnetic body 30B have the same cross-sectional shape and cross-sectional dimensions, and extend along the second direction (the left-right direction in FIG. 8). In the third direction (vertical direction in FIG. 8), the first magnetic body 30A is in contact with each the juxtapositional portions 21 of the first and second coil conductors 20A and 20B in the end surfaces 30c and 30d. The first magnetic body 30A may be in direct or indirect contact with the juxtapositional portions 21. In the case of the indirect contact, an insulating film provided on the first magnetic body 30A or the coil conductor 20 may be interposed between the first magnetic body 30A and the juxtapositional portions 21 of the coil conductors 20, or the gap between the first magnetic body 30A and the juxtapositional portions 21 of the coil conductor 20 may be filled with magnetic powder-containing resin. When the gap between the first magnetic body 30A and the juxtapositional portions 21 of the coil conductors 20 is filled with magnetic-powder-containing resin, the magnetic-powder-containing resin may be the same material that constitutes the second element body portion 12. Similarly, in the third direction, the second magnetic body 30B located on the end surface 10c side of the element body 10 is in contact with the juxtapositional portions 21 of the first coil conductor 20A in the end surface 30d, and the second magnetic body 30B located on the end surface 10d side of the element body 10 is in contact with the juxtapositional portions 21 of the second coil conductor 20B in the end surface 30c. The second magnetic bodies 30B may be in direct or indirect contact with the juxtapositional portions 21. In the case of the indirect contact, an insulating film provided on the second magnetic body 30B or the coil conductor 20 may be interposed between the second magnetic body 30B and the juxtapositional portion 21 of the coil conductor 20, or the gap between the second magnetic body 30B and the juxtapositional portion 21 of the coil conductor 20 may be filled with magnetic powder-containing resin. When the gap between the second magnetic body 30B and the juxtapositional portion 21 of the coil conductor 20 is filled with magnetic-powder-containing resin, the magnetic-powder-containing resin may be the same material that constitutes the second element body portion 12. In the cross-section shown in FIG. 8, the first magnetic body 30A and each second magnetic body 30B may have different cross-sectional shapes and cross-sectional dimensions.

As shown in FIG. 8, the side surfaces 30e and 30f of the magnetic bodies 30 protrude outward from the juxtapositional portions 21A and 21B of the coil conductors 20A and 20B, respectively, and are close to the side surfaces 10e and 10f of the element body 10. In the present embodiment, the side surfaces 30e and 30f of the magnetic bodies 30 protrude from the juxtapositional portions 21A and 21B of the coil conductors 20A and 20B, respectively, by length L2. The length L1 of the third area S3 in the second direction is shorter than the length L2 (L1<L2). Similarly, the fourth area S4 in the second direction is shorter than the Length L2. Thereby, the leakage flux in the side surfaces 10e and 10f of the element body 10 can be suppressed while increasing the inductance in the inductor 1.

As shown in FIGS. 1 and 2, the first element body portion 11 integrally covers, from the upper surface 10a side of the element body 10, the upper surface 22a of the connecting portion 22 of each of the first and second coil conductors 20A and 20B, the upper surface 30a of each the magnetic bodies 30, and the upper surfaces of each of the portions of the second area S2, the third area S3, and the fourth area S4 of the second element body portion 12. The height position of the interface between the first element body portion 11 and the second element body portion 12 can be appropriately set. In the present embodiment, the interface between the first element body portion 11 and the second element body portion 12 is located between the upper surface 22a and the lower surface 22b of the connecting portion 22. The second element body portion 12 is interposed at least partially between the connection part 26 of the juxtapositional portion 21 and the connecting portion 22 and the first element body portion 11. In this case, the lower surface 22b of the connecting portion 22 is entirely covered with the magnetic powder-containing resin constituting the second element body portion 12. The third element body portion 13 integrally covers the lower surfaces 30b of the magnetic bodies 30 and lower surfaces of portions of the first areas S1, portions of the third areas S3, portions of the fourth areas S4, and portions of the fifth areas S5 of the second element body portion 12 from the lower surface 10b side of the element body 10. The height position of the interface between the second element body portion 12 and the third element body portion 13 can also be appropriately set.

In the second element body portion 12, the portion of the fifth area S5 may be made of non-magnetic resin instead of magnetic material.

In the inductor 1 described above, when a voltage is applied via each of the terminal portions 23, current flows through each of the first coil conductor 20A and the second coil conductor 20B, at which time coupling may occur between the first coil conductor 20A and the second coil conductor 20B. However, in the inductor 1, since the first magnetic body 30A is provided, coupling between the first coil conductor 20A and the second coil conductor 20B is suppressed, and since the pair of the second magnetic body 30B is additionally provided, high inductance can be realized.

The second magnetic body 30B is not limited to the configuration described above as long as it is in contact with the juxtapositional portions 21 of the coil conductors 20.

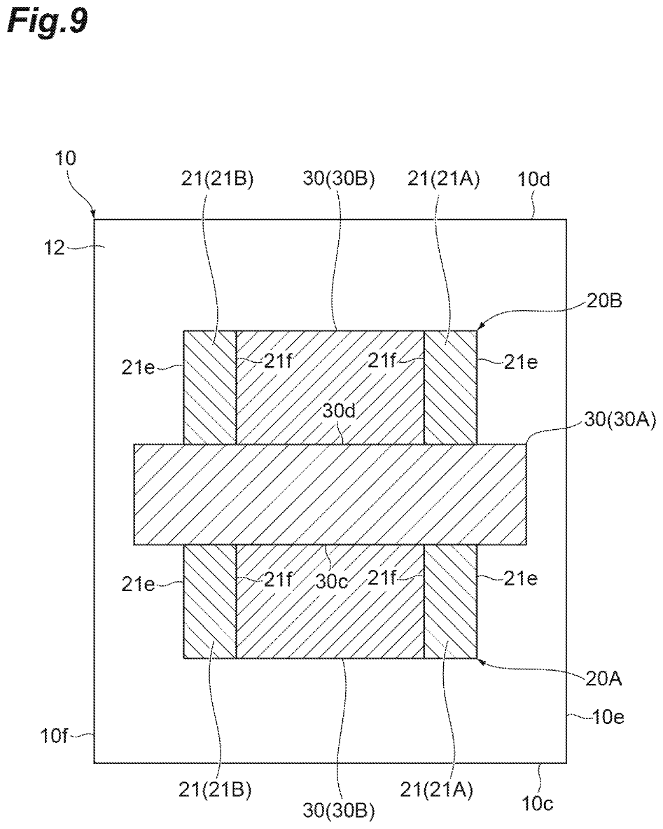

For example, the pair of second magnetic bodies 30B may be located between the pair of the juxtapositional portions 21 of each the coil conductors 20, as shown in FIG. 9. In the cross-section shown in FIG. 9, in the third direction, the second magnetic body 30B located on the end surface 10c side of the element body 10 is in contact with the first magnetic body 30A in the end surface 30c, and the second magnetic body 30B located on the end surface 10d side of the element body 10 is in contact with the first magnetic body 30A in the end surface 30d. Each of the second magnetic bodies 30B may be in direct or indirect contact with the juxtapositional portions 21. In the case of the indirect contact, an insulating film provided on the first magnetic body 30A or the second magnetic body 30B may be interposed between the magnetic bodies 30, and the gap between the magnetic bodies 30 may be filled with the magnetic powder-containing resin. In the embodiment shown in FIG. 9, the first magnetic body 30A and the second magnetic body 30B may be coupled to each other.

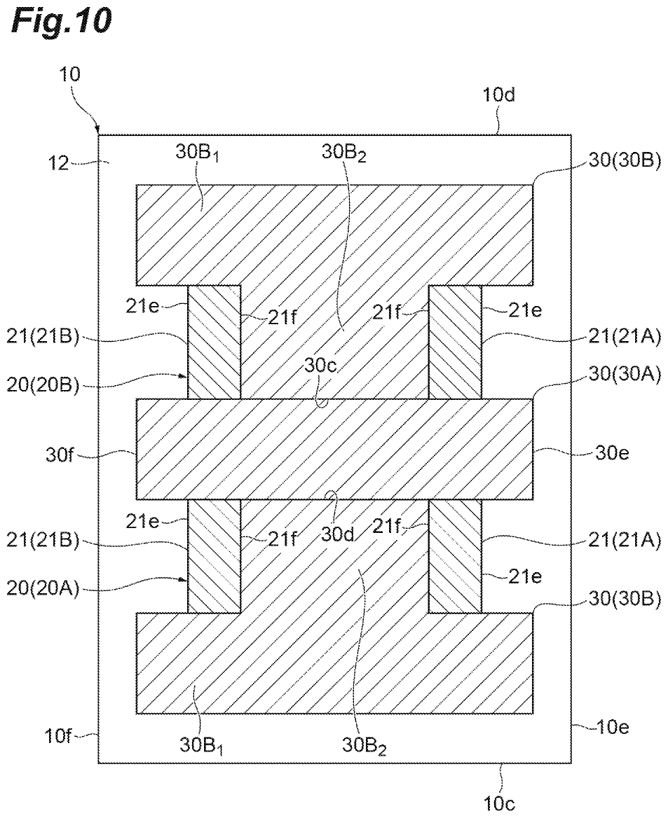

Further, as shown in FIG. 10, the pair of second magnetic bodies 30B may be formed by combining the second magnetic body 30B shown in FIG. 8 and the second magnetic body 30B shown in FIG. 9. That is, in the cross-section shown in FIG. 10, the second magnetic body 30B located on the end surface 10c side of the element body 10 in the third direction includes a first portion 30B₁ having the same cross-sectional shape as the first magnetic body 30A and being in contact with the juxtapositional portions 21 of the first coil conductor 20A in the end surface 30d, and a second portion 30B₂ interposed between the pair of the juxtapositional portions 21 of the first coil conductor 20A and being in contact with the first magnetic body 30A in the end surface 30d. Similarly, the second magnetic body 30B located on the end surface 10d side of the element body 10 in the third direction includes a first portion 30B₁ having a cross-sectional shape similar to that of the first magnetic body 30A and being in contact with the juxtapositional portions 21 of the second coil conductor 20B in the end surface 30c, and a second portion 30B₂ interposed between the pair of the juxtapositional portions 21 of the second coil conductor 20B and being in contact with the second magnetic body 30B in the end surface 30c. Each of the second magnetic bodies 30B may be in direct or indirect contact with the juxtapositional portions 21. In the case of the indirect contact, an insulating film provided on the surface of the coil conductor 20 or the surface of the second magnetic body 30B may be interposed therebetween, or may be filled with magnetic powder-containing resin therebetween. In the case of the indirect contact, an insulating film provided on the first magnetic body 30A or the second magnetic body 30B may be interposed between the magnetic bodies 30, and the gap of the magnetic bodies 30 may be filled with magnetic powder-containing resin. In the embodiment shown in FIG. 10, the first magnetic body 30A and the second magnetic body 30B may be coupled to each other. Further, the first portion 30B₁ and the second portion 30B₂ of the second magnetic body 30B may be constituted by magnetic bodies coupled to each other or magnetic bodies separated from each other.

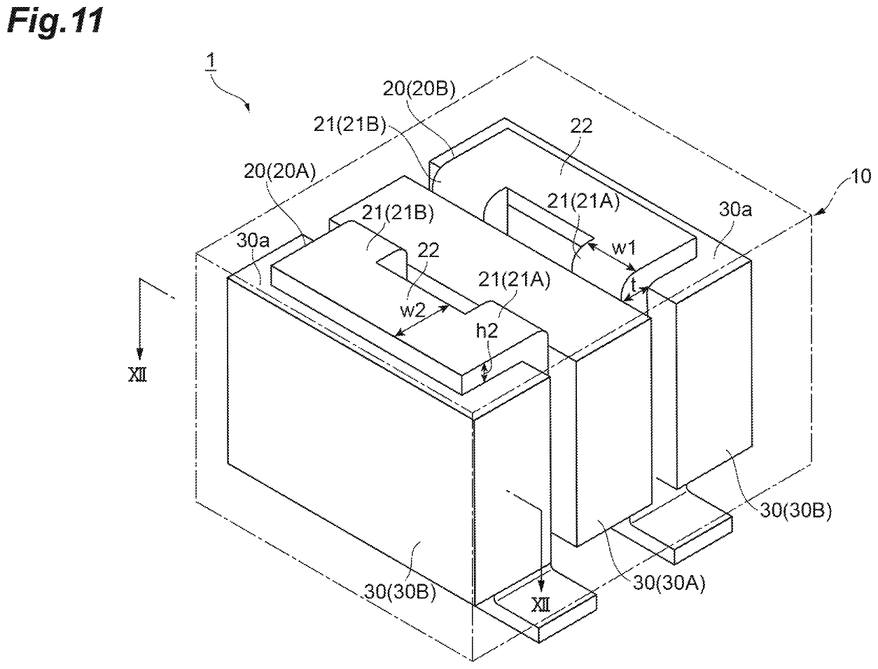

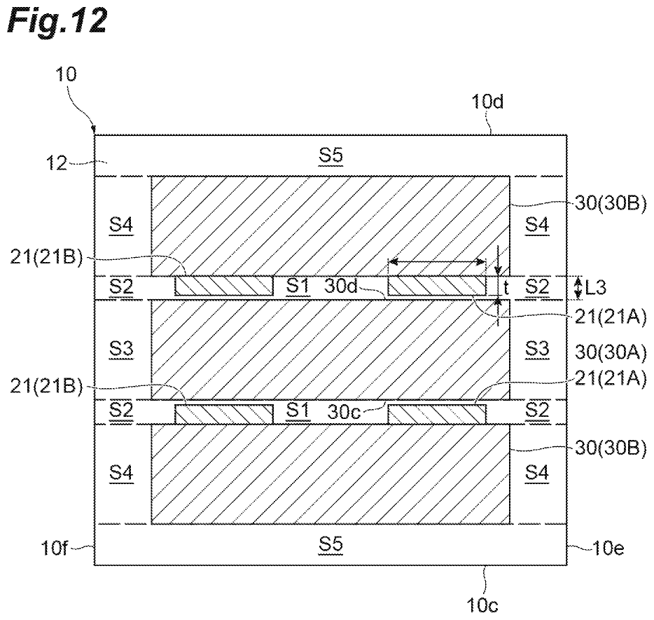

The configuration of each the coil conductor 20 is not limited to the above-described configuration, and can be variously modified. For example, as shown in FIG. 11, the connecting portion 22 of each the coil conductors 20 may be bent outward in the third direction from the juxtapositional portions 21. The length W2 (width) of each the connecting portion 22 in the third direction can be designed to be longer than the length W1 (width) of each the juxtapositional portions 21 in the second direction, and the electric resistance of the coil conductor 20 can be further reduced. The height h2 (height) of each the connecting portion 22 in the first direction can be designed to be lower than the height of the connecting portion 22 not bent as shown in FIG. 4, it is possible to reduce the height of the coil conductor 20 and the inductor 1. Further, as shown in FIG. 12, in the cross section perpendicular to the first direction, the length W1 of the juxtapositional portion 21 in the second direction can be designed to be longer than the length t (thicknesses) in the third direction. In this case, the surface of the coil conductor 20 facing the first magnetic body 30A is increased, and high inductance can be obtained. Further, in the cross section perpendicular to the first direction, the length L3 of the portion of the second area S2 of the second element body portion 12 of the element body 10 in the third direction can be designed to be longer than the length t of the portion of each the juxtapositional portion 21 in the third direction. In this case, the magnetic powder-containing resin constituting the second element body portion 12 can be increased, thereby realizing high inductance. In addition, interference and contact between each the coil conductor 20 and the first magnetic body 30A during assembly can be significantly avoided, thereby avoiding damage to the components comprising the inductor 1.

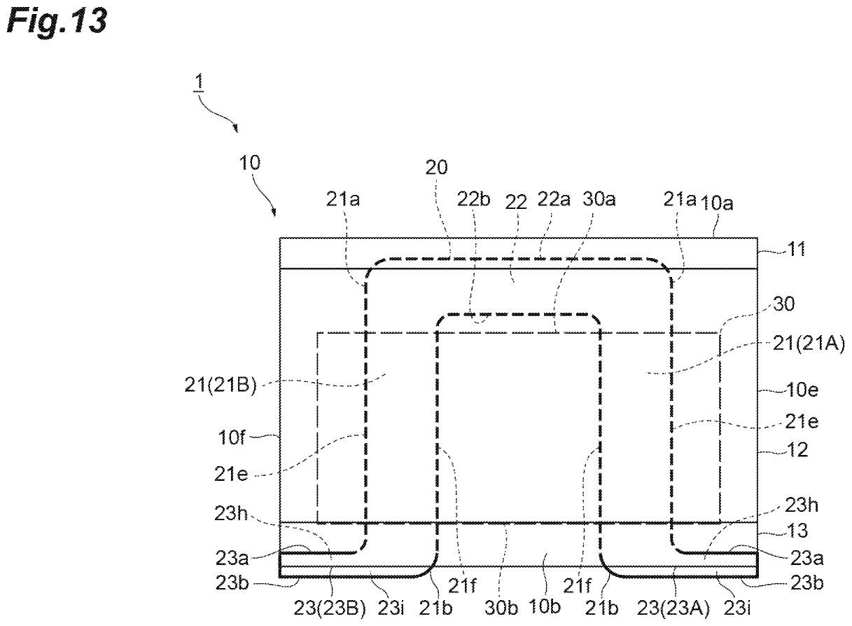

The pair of the terminal portions 23 may be designed to be embedded partially in the third element body portion 13 of the element body 10, as shown in FIG. 13. In the embodiment shown in FIG. 13, an upper end portion 23h of each the terminal portion 23 is embedded in the third element body portion 13 in the element body 10, and a lower end portion 23i of each the terminal portion 23 is exposed from the third element body portion 13. The configuration in which a part of the terminal portion 23 is embedded in the element body 10 may increase the terminal strength and improve the mountability.

As described above, as a result of intensive studies, the inventors have newly found a technique capable of improving inductance while suppressing coupling between coil conductors in an inductor.

In the inductor 1, inductance is improved while suppressing coupling between coil conductors.

The technology according to the present disclosure includes, but is not limited to, the following configuration examples.

The inductor includes an element body including a first body portion constituted of material containing magnetic material, the element body having a rectangular parallelepiped outer shape and having a pair of first side surfaces facing each other in a first direction, a pair of second side surfaces facing each other in a second direction perpendicular to the first direction, and a pair of third side surfaces facing each other in a third direction perpendicular to both the first direction and the second direction, a first coil conductor having a first conductor extending along the first direction in the element body, a second conductor extending along the first direction in the element body and adjacent to the first conductor in the second direction, and a third conductor extending along the second direction in the element body and connecting end portions on one side in the first direction of the first and second conductors, a second coil conductor aligned with the first coil conductor in the third direction, the second coil conductor having the first conductor, the second conductor, and the third conductor, a first magnetic body provided in the element body and having a magnetic permeability higher than that of the first body portion, the magnetic body having a rectangular parallelepiped outer shape and interposed between the first coil conductor and the second coil conductor in the third direction and having a pair of forth side surfaces facing each other in the first direction, a pair of fifth side surfaces facing each other in the second direction, and a pair of sixth side surfaces facing each other in the third direction, and a pair of second magnetic bodies provided in the element body and having a magnetic permeability higher than that of the first body portion, each of the second magnetic bodies having a rectangular parallelepiped outer shape, provided in an area different from an area where the first magnetic body is provided in a cross section perpendicular to the first direction, and having a pair of seventh side surfaces facing each other in the first direction, a pair of eighth side surfaces facing each other in the second direction, and a pair of ninth side surfaces facing each other in the third direction, wherein, in a cross section perpendicular to the first direction, the first element body portion of the element body is located at least outside of the first and second conductors of each of the first and second coil conductors in the second direction.

In the inductor, when current flows through each of the first coil and second conductors, coupling may occur between the first and second coil conductors. In the inductor, since not only the first magnetic body but also the pair of second magnetic bodies are additionally provided, it is possible to improve inductance while suppressing coupling between the first coil and second conductors.

In the inductor according to another aspect, in the cross-section perpendicular to the first direction, the pair of second magnetic bodies are located outside the first and second conductors of each of the first and second coil conductors in the third direction, and extend along the second direction. In this case, fine alignment of the pair of second magnetic bodies with respect to the first and second coil conductors is not necessary, and it can be easily manufactured.

In the inductor according to another embodiment, in the cross section perpendicular to the first direction, the pair of second magnetic bodies are respectively located between the first and second conductors of each of the first and second coil conductors. In this case, even if the pair of second magnetic bodies are disposed, the length in the third direction are not extended, and thus it is possible to reduce the dimensions of the component.

In the inductor according to another aspect, in the cross section perpendicular to the first direction, the pair of second magnetic bodies includes a first portion located outside the first and second conductors of each of the first and second coil conductors in the third direction and extends along the second direction, and second portion located between the first and second conductors of each of the first and second coil conductors, the first portion and the second portion are connected to each other. In this case, it is possible to arrange the magnetic body having a large capacity in the element body, suppress coupling between the coil conductors, and further improve inductance.

In the inductor according to another aspect, the fourth side surface located on one side in the first direction of the pair of fourth side surfaces of the first magnetic body and the seventh side surface located on one side in the first direction of the pair of seventh side surfaces of the second magnetic body are located on the other side in the first direction of the surface on one side of the third conductor of each of the first and second coil conductors. In this case, since the magnetic body is hardly affected by the magnetic field generated in each of the first conductors of the second coil conductor and the third coil conductor, the magnetic flux distribution in the magnetic body becomes uniform, and the saturation characteristics are improved.

In the inductor according to another aspect, the pair of fifth side surfaces of the first magnetic body and the pair of eighth side surfaces of the second magnetic body protrude outward from the first and second conductors of each of the first and second coil conductors, respectively, and are close to the pair of the second side surfaces of the element body. In this case, it is possible to suppress coupling between the coil conductors and further improve inductance.

In the inductor according to another aspect, in the cross section perpendicular to the first direction, the first element body portion of the element body is further located outside the first and second magnetic bodies in the second direction. In this case, it is possible to suppress leakage flux on the side surface of the element body while increasing inductance.

In the inductor according to another aspect, the protruding lengths of the pair of fifth side surfaces of the first magnetic body and the pair of eighth side surfaces of the second magnetic body from the first and second conductors of the first and second coil conductors are longer than lengths of the first element body portions of the element body located outside the first and second magnetic bodies in the second direction. In this case, it is possible to suppress leakage flux on the side surface of the element body while increasing inductance.

In the inductor according to another aspect, in the cross section perpendicular to the first direction, lengths in the third direction of the first element body portion of the element body located outside the first and second conductors of each of the first and second coil conductors in the second direction are longer than lengths in the third direction of the first and second conductors of each of the first and second coil conductors. In this case, the magnetic powder-containing resin constituting the element body portion increases, and thus high inductance can be realized. In addition, it is possible to avoid interference or contact between the coil conductor and the magnetic body during assembly, thereby avoiding damage to members constituting the inductor.

In the inductor according to another embodiment, in the cross section perpendicular to the first direction, the first and second conductors of each of the first and second coil conductors are in contact with the first magnetic body. In this case, since the first magnetic body and the first and second coil conductors are in contact with each other, distances therebetween are stable, and a stable inductance value can be obtained.

In the inductor according to another embodiment, in the cross section perpendicular to the first direction, the first and second conductors of each of the first and second coil conductors are in contact with the second magnetic body. In this case, since the second magnetic body and the first and second coil conductor are in contact with each other, distances therebetween are stable, and a stable inductance value can be obtained.

In the inductor according to another embodiment, in the cross section perpendicular to the first direction, lengths of the first and second conductors of each of the first and second coil conductors in the second direction are longer than that in the third direction. In this case, the surface of the coil conductor facing the first magnetic body having high magnetic permeability increases, and high inductance can be obtained.

In the inductor according to another aspect, the third conductor of each of the first and second coil conductors is bent outward in the third direction from the first and second conductors. In this case, it is possible to reduce the height dimension of the coil conductor while reducing the DC resistance of the current flowing through the coil conductor.

In the inductor according to another embodiment, lengths of the third portions of each of the first and second coil conductors in the third direction are longer than lengths of the first and second conductors of each of the first and second coil conductors in the second direction. In this case, the DC resistance of the current flowing through the coil conductor can be reduced while reducing the height of the coil conductor.

In the inductor according to another embodiment, the first and second magnetic bodies are formed by stacking a plurality of magnetic ribbons made of amorphous ribbon or nanocrystalline ribbon in the first direction via an insulation layer. By using such a material having high magnetic permeability, saturation magnetization is increased, and excellent DC superposition characteristics can be realized. Further, since the magnetic field generated at the first and second conductors of each of the coil conductors is generated in a plane perpendicular to the first direction, the magnetic field is not affected by a decrease in magnetic permeability due to an insulation layer. In addition, since the insulation layer is interposed in the first direction, the generation of eddy-current loss can be suppressed.

In the inductor according to another embodiment, the first and second magnetic bodies include a plurality of magnetic blocks, each of the magnetic blocks is formed by stacking in the first direction a plurality of magnetic ribbons made of amorphous ribbon or nanocrystalline ribbon via an insulation layer. The plurality of magnetic body blocks are stacked in the first direction. By using such a material having high magnetic permeability, saturation magnetization is increased, and excellent DC superposition characteristics can be realized. Further, as the number of laminations of the magnetic bodies increases, the position shift due to lamination is more likely to occur. Therefore, by dividing the magnetic body into a plurality of blocks and laminating the blocks, it is possible to reduce the above position shift and improve the dimensional accuracy.

In the inductor according to another aspect, the pair of fifth side surfaces and the pair of sixth side surfaces of the first magnetic body and the pair of eighth side surfaces and the pair of ninth side surfaces of the second magnetic body are concave-convex surfaces, and the concave-convex surfaces are in contact with the first element body portion of the element body. When the material constituting the first element body portion enters the concave-convex surfaces, the space that cause a decrease in inductance are filled, high inductance can be obtained, and close contact between the element body and the first and second magnetic bodies can be strengthened.

In the inductor according to another embodiment, the element body further comprises a second element body portion made of a resin-containing material, the second element body portion integrally covering a surface on the one side in the first direction of the third conductors of each of the first and second coil conductors, a surface on the one side in the first direction of the pair of the fourth side surfaces of the first magnetic body, a surface on the one side in the first direction of the pair of seventh side surfaces of the second magnetic body, and a surface on the one side in the first direction of the pair of the first side surfaces of the first element body portion of the element body. In this case, the flux components in the first direction generated in the third conductor can be reduced by the second element body portion made of the non-magnetic resin, and the generation of eddy-current loss due to the flux components in the first direction can be further reduced.

In the inductor according to another aspect, in the cross-section perpendicular to the first direction, the first element body portion of the element body is further located outside the second magnetic bodies in the third direction. In this case, it is possible to reduce the leakage flux of the end surface of the element body while increasing the inductance.

In a inductor according to another aspect, the element body further includes a third element body portion integrally covering a surface on the other side in the first direction of the pair of fourth side surfaces of the first magnetic body, a surface on the other side in the first direction of the pair of seventh side surfaces of the second magnetic body, and a surface on the other side in the first direction of the pair of first side surfaces of the first element body portion. In this case, it is possible to reduce the leakage flux of the lower surface of the element body while increasing the inductance.

In a inductor according to another aspect, the first and second coil conductors further include a fourth conductor extending away from an end portion on the other side in the first direction of each of the first and second conductor, an end portion of the fourth conductor on the one side in the first direction is embedded in the third element body portion, and an end portion of the fourth conductor on the other side in the first direction is exposed from the third element body portion. In this case, it is possible to increase the strength of the fourth conductor that can function as a terminal of the coil conductor, and to improve mountability.

A DC-DC converter according to an embodiment of the present disclosure includes the above inductor. Accordingly, it is possible to obtain a DC-DC converter including a inductor in which inductance is improved while suppressing coupling between coil conductors.

Note that the present disclosure is not limited to the above-described embodiment, and various modifications can be made without departing from the scope of the present disclosure. For example, three or more coil conductors may be included in the inductor. Four of more magnetic bodies may be included in the inductor.

1. An inductor comprising:
an element body including a first body portion constituted of material containing magnetic material, the element body having a rectangular parallelepiped outer shape and having a pair of first side surfaces facing each other in a first direction, a pair of second side surfaces facing each other in a second direction perpendicular to the first direction, and a pair of third side surfaces facing each other in a third direction perpendicular to both the first direction and the second direction;
a first coil conductor having a first conductor extending along the first direction in the element body, a second conductor extending along the first direction in the element body and adjacent to the first conductor in the second direction, and a third conductor extending along the second direction in the element body and connecting end portions on one side in the first direction of the first and second conductors;
a second coil conductor aligned with the first coil conductor in the third direction, the second coil conductor having the first conductor, the second conductor, and the third conductor;
a first magnetic body provided in the element body and having a magnetic permeability higher than that of the first body portion, the magnetic body having a rectangular parallelepiped outer shape and interposed between the first coil conductor and the second coil conductor in the third direction and having a pair of forth side surfaces facing each other in the first direction, a pair of fifth side surfaces facing each other in the second direction, and a pair of sixth side surfaces facing each other in the third direction; and
a pair of second magnetic bodies provided in the element body and having a magnetic permeability higher than that of the first body portion, each of the second magnetic bodies having a rectangular parallelepiped outer shape, provided in an area different from an area where the first magnetic body is provided in a cross section perpendicular to the first direction, and having a pair of seventh side surfaces facing each other in the first direction, a pair of eighth side surfaces facing each other in the second direction, and a pair of ninth side surfaces facing each other in the third direction;
wherein, in a cross section perpendicular to the first direction, the first element body portion of the element body is located at least outside of the first and second conductors of each of the first and second coil conductors in the second direction.

2. The inductor according to claim 1, wherein, in a cross section perpendicular to the first direction, the pair of second magnetic bodies are located outside the first and second conductors of each of the first and second coil conductors in the third direction, and extend along the second direction.

3. The inductor according to claim 1, wherein, in a cross section perpendicular to the first direction, the pair of second magnetic bodies are respectively located between the first and second conductors of each of the first and second coil conductors.

4. The inductor according to claim 1, wherein, in a cross section perpendicular to the first direction, the pair of second magnetic bodies includes a first portion located outside the first and second conductors of each of the first and second coil conductors in the third direction and extends along the second direction, and second portion located between the first and second conductors of each of the first and second coil conductors, the first portion and the second portion are connected to each other.

5. The inductor according to claim 1, wherein the fourth side surface located on one side in the first direction of the pair of fourth side surfaces of the first magnetic body and the seventh side surface located on one side in the first direction of the pair of seventh side surfaces of the second magnetic body are located on the other side in the first direction of the surface on one side of the third conductor of each of the first and second coil conductors.

6. The inductor according to claim 1, wherein the pair of fifth side surfaces of the first magnetic body and the pair of eighth side surfaces of the second magnetic body protrude outward from the first and second conductors of each of the first and second coil conductors, respectively, and are close to the pair of the second side surfaces of the element body.

7. The inductor according to claim 1, wherein, in a cross section perpendicular to the first direction, the first element body portion of the element body is further located outside the first and second magnetic bodies in the second direction.

8. The inductor according to claim 7, wherein protruding lengths of the pair of fifth side surfaces of the first magnetic body and the pair of eighth side surfaces of the second magnetic body from the first and second conductors of the first and second coil conductors are longer than lengths of the first element body portions of the element body located outside the first and second magnetic bodies in the second direction.

9. The inductor according to claim 1, wherein, in a cross section perpendicular to the first direction, lengths in the third direction of the first element body portion of the element body located outside the first and second conductors of each of the first and second coil conductors in the second direction are longer than lengths in the third direction of the first and second conductors of each of the first and second coil conductors.

10. The inductor according to claim 1, wherein in a cross section perpendicular to the first direction, the first and second conductors of each of the first and second coil conductors are in contact with the first magnetic body.

11. The inductor according to claim 1, wherein in a cross section perpendicular to the first direction, the first and second conductors of each of the first and second coil conductors are in contact with the second magnetic body.

12. The inductor according to claim 1, wherein, in a cross section perpendicular to the first direction, lengths of the first and second conductors of each of the first and second coil conductors in the second direction are longer than that in the third direction.

13. The inductor according to claim 1, wherein the third conductor of each of the first and second coil conductors is bent outward in the third direction from the first and second conductors.

14. The inductor according to claim 1, wherein lengths of the third portions of each of the first and second coil conductors in the third direction are longer than lengths of the first and second conductors of each of the first and second coil conductors in the second direction.

15. The inductor according to claim 1, wherein the first and second magnetic bodies are formed by stacking a plurality of magnetic ribbons made of amorphous ribbon or nanocrystalline ribbon in the first direction via an insulation layer.

16. The inductor according to claim 1, wherein the first and second magnetic bodies include a plurality of magnetic blocks, each of the magnetic blocks is formed by stacking in the first direction a plurality of magnetic ribbons made of amorphous ribbon or nanocrystalline ribbon via an insulation layer.

17. The inductor according to claim 16, wherein the plurality of magnetic body blocks are stacked in the first direction.

18. The inductor according to claim 1, wherein the pair of fifth side surfaces and the pair of sixth side surfaces of the first magnetic body and the pair of eighth side surfaces and the pair of ninth side surfaces of the second magnetic body are concave-convex surfaces, and the concave-convex surfaces are in contact with the first element body portion of the element body.

19. The inductor according to claim 1, wherein the element body further comprises a second element body portion made of a resin-containing material, the second element body portion integrally covering a surface on the one side in the first direction of the third conductors of each of the first and second coil conductors, a surface on the one side in the first direction of the pair of the fourth side surfaces of the first magnetic body, a surface on the one side in the first direction of the pair of seventh side surfaces of the second magnetic body, and a surface on the one side in the first direction of the pair of the first side surfaces of the first element body portion of the element body.

20. The inductor according to claim 1, wherein in a cross-section perpendicular to the first direction, the first element body portion of the element body is further located outside the second magnetic bodies in the third direction.

21. The inductor according to claim 1, wherein the element body further includes a third element body portion integrally covering a surface on the other side in the first direction of the pair of fourth side surfaces of the first magnetic body, a surface on the other side in the first direction of the pair of seventh side surfaces of the second magnetic body, and a surface on the other side in the first direction of the pair of first side surfaces of the first element body portion.

22. The inductor according to claim 21, wherein the first and second coil conductors further include a fourth conductor extending away from an end portion on the other side in the first direction of each of the first and second conductor, an end portion of the fourth conductor on the one side in the first direction is embedded in the third element body portion, and an end portion of the fourth conductor on the other side in the first direction is exposed from the third element body portion.

23. A DC-DC converter comprising the inductor according to claim 1.
